(19) United States
(12) Patent Application Publication
(10) Pub. No.: US 2004/0094751 A1
(43) Pub. Date: May 20, 2004

(54) Composition for filling through-holes in printed wiring boards

(76) Inventor: Toshiaki Ogiwara, Utsunomiya-shi (JP)

Correspondence Address: Lois A Santopietro, E I du Pont de Nemours and Company, Legal- Patent, Wilmington, DE, 19898, US

(21) Appl. No.: 10/468,425

(22) PCT Filed: Mar. 25, 2002
(86) PCT No.: PCT/US02/09118

(51) Int. Cl. H01B 1/00

(52) U.S. Cl. 252/500

(57) ABSTRACT

A conductor composition comprising an electrically conductive powder and a binder, wherein the ratio of conductive powder to binder is from 95:5 to 70:30, which binder is composed of (a) an epoxy compound that is semisolid at ordinary room temperature and has an average number of functional groups greater than 2, (b) a monofunctional reactive diluting agent which has substantially no volatility at ordinary room temperature, (c) a curing agent, and (d) a curing catalyst. The composition offers good hole filling properties without void and provides a good interlayer connection in multilayer printed wiring boards with through-holes that may be plated or non-plated.

### FIELD OF INDUSTRIAL USE

The present invention relates to a conductor composition used to fill through-holes in printed wiring boards (PWB). The filled through-holes achieve interlayer connections between the circuit layers of the PWBs.

### BACKGROUND OF THE INVENTION

Prior-art conductor thick film compositions for filling through-holes such as those described in Japanese Patent No. 2603053 and JP-A 11-209662 have made use of a composition comprising a bifunctional liquid epoxy resin having a viscosity at ordinary room temperature of not more than 15 Pa.s or a solid epoxy resin, in combination with a reactive diluting agent and a solid latent curing agent.

However, the viscosity of the composition must be lowered to some degree when attempting to fill through-holes with a conductor composition so as to keep voids from forming therein. Because this necessitates a reduction in the amount of electrically conductive powder in the binder or the use of a large amount of aliphatic epoxy compound, the unfortunate result has been to raise the resistance of the cured composition or lower its glass transition temperature.

JP-A 5-20918 describes the use of a composition comprising an epoxy resin which is free of hydroxyl groups on the molecule in combination with an acid anhydride. However, obtaining a hydroxyl group-free epoxy resin requires repeated molecular distillation. In addition, because the resulting epoxy resin has a high purity, it tends to crystallize, which has a very significant and adverse effect on the efficiency of operations.

It is therefore an object of the present invention to provide a conductor composition which exhibits a suitable viscosity for filling through-holes without reducing the amount of electrically conductive powder in the composition, which minimizes the drop in the glass transition temperature, and which has a low resistance and is capable of achieving good interlayer connections in plated and non-plated through-holes.

### SUMMARY OF THE INVENTION

The invention is directed to a conductor composition comprising an electrically conductive powder and a binder, wherein the ratio of conductive powder to binder is from 95:5 to 70:30, and wherein the binder comprises:

(a) an epoxy compound that is semisolid at ordinary room temperature and has an average number of functional groups greater than 2;

(b) a monofunctional reactive diluting agent which has substantially no volatility at ordinary room temperature;

(c) a curing agent; and

(d) a curing catalyst.

### DETAILED DESCRIPTION OF THE INVENTION

The invention provides a conductor composition comprising an electrically conductive powder and an epoxy resin binder, wherein the epoxy resin binder base is composed of an epoxy compound having an average number of functional groups greater than 2 and a monofunctional reactive diluting agent as the essential constituents. The inventive composition includes a curing agent that is selected from a cationic polymerization initiator capable of triggering a curing reaction even when present in a small amount or a curing agent that is liquid at an ordinary room temperature, and a small amount of a curing catalyst.

The through-hole conductor thick film composition comprises an electrically conductive powder and a binder, wherein the ratio of conductive powder to binder is from 95:5 to 70:30. The electrically conductive powders in a given composition could comprise a single type of powder, mixtures thereof, alloys thereof, compounds of several elements or combinations or mixtures of the aforementioned. Examples of such powders include: gold, silver, copper, nickel, aluminum, platinum, palladium, molybdenum, tungsten, tantalum, tin, indium, lanthanum, gadolinium, boron, ruthenium, cobalt, titanium, yttrium, europium, gallium, sulfur, zinc, silicon, magnesium, barium, cerium, strontium, lead, antimony, conductive carbon, and combinations thereof and others common in the art of thick film compositions.

Examples of the epoxy resin having an average number of functional groups greater than 2 which may be used in the invention include compounds prepared by combining epichlorohydrin with the condensation product of an alkylphenol (e.g., phenol novolak, cresol novolak) with formaldehyde or dicyclopentadiene, and compounds prepared by combining such a condensation product with a bisphenol-type epoxy resin, a polyfunctional epoxy compound such as trihydroxytriphenylmethane triglycidyl ether, or a glycidylamine-type epoxy compound. The epoxy resin is preferably semi-solid at an ordinary room temperature.

The monofunctional reactive diluting agent used in the invention may be the glycidyl ether of a higher alcohol or a compound prepared from an alkylphenol (e.g., nonylphenol) and epichlorohydrin. A reactive diluting agent having a vapor pressure of not more than 0.5 mmHg is preferred. A reactive diluting agent with a vapor pressure greater than 0.5 mmHg tends to volatilize easily, which may cause the viscosity of the composition to increase during printing or storage.

The ratio of the semisolid epoxy compound having an average number of functional groups greater than 2 to the monofunctional reactive diluting agent is preferably from 90:10 to 50:50. An epoxy resin ratio greater than 90% may result in a loss of the diluting agent effects, thereby lowering the viscosity of the composition. On the other hand, a reactive diluting agent ratio in excess of 50% may make it impossible to achieve a three-dimensional matrix during curing.

Illustrative examples of cationic polymerization initiators that may be used in the invention include tertiary amines, imidazoles, Lewis acid salts (BF₃-amine complexes), and Brønsted acid salts (aromatic sulfonium salts, aromatic diazonium salts). Lewis acid salts are preferred because they dissolve in epoxy resins and exhibit latency.

The relative proportions in which the epoxy resin base (which includes the reactive diluting agent) and the cationic polymerization initiator are used in the invention may be selected from a range of 99:1 to 90:10. At less than 1% of initiator, the curing reaction tends to be difficult to trigger. On the other hand, more than 10% of initiator may cause the curing reaction to occur instantaneously, which may lead to undesirable results such as void formation when the conductor composition is filled into through-holes and cured.

Illustrative examples of liquid acid anhydride curing agents that may be used in the invention include dicarboxylic anhydrides and derivatives thereof, such as hexahydrophthalic anhydride, methyl hexahydrophthalic anhydride and methyl tetrahydrophthalic anhydride; and derivatives of polycarboxylic anhydrides, such as trimellitic anhydride triglyceride. When an acid anhydride is employed as the curing agent, a curing catalyst such as a tertiary amine, imidazole or amine compound may also be used. The use of an amine compound is preferable from the standpoint of storage stability.

The amount of acid anhydride curing agent used in the invention may be selected from a range of 0.7 to 1.3 equivalent per epoxy functional group in the epoxy resin base. An amount of acid anhydride curing agent outside of this range may result in poor curing.

The amount of curing catalyst may be selected from a range of 1 to 5 parts per 100 parts of the mixture of the epoxy resin base and the curing agent. At less than 1 part of curing catalyst, the epoxy resin base and the curing agent may fail to react, whereas more than 5 parts may increase the composition viscosity and result in a poor storage stability.

The conductor composition of the present invention is typically manufactured by a mechanical mixing means (e.g., on a roll mill) to form a paste-like composition having suitable consistency and rheology for screen printing, and has preferably a viscosity ratio which is defined as a viscosity measurement at 0.5 rpm divided by a viscosity measurement at 10 rpm and 25° C. using # 14 spindle and utility cup with a Brookfield Viscometer being not larger than 7.5. The resulting paste exhibits good hole filling properties without void formation in the body of the via fill. The filled vias with the resulting paste is shaped so as to be easily polished followed by a metal plating being applied on top of the filled vias so that electrical parts are mounted directly on such plated top of the filled vias.

### EXAMPLES

The formulations for the compositions found in the examples and testing results of the compositions are summarized in Table 1.

### Example 1

The following ingredients were mixed, blended and dispersed in a three-roll mill yielding a conductor composition having a viscosity, as measured at 25° C. with a Brookfield viscometer, of 40 Pa.s: 10 parts of phenol epoxy novolak (DEN431, produced by The Dow Chemical Co.; viscosity at 25° C., 60 Pa.s), 4.5 parts of monofunctional alkyl glycidyl ether (EPOSIL 759, produced by Air Products and Chemicals, Inc.), 0.75 part of boron trifluoride-ethylamine complex, 42.5 parts of spherical silver powder having an average particle size of 7 μm, and 42.5 parts of flake-like silver powder having an average particle size of 2.5 μm.

The conductor composition was printed onto circuits to a film thickness of 40 μm with a printer, then cured at 160° C. for 1 hour, after which the resistivity was measured. The volume resistivity was 1.4×10⁻⁴ Ω cm. The glass transition point of the cured product obtained by curing under the same conditions was 119° C. The percent weight loss on curing was 0.25%.

This conductor composition was filled into 0.3 mm diameter through-holes in a 1 mm thick FR-4 board by printing. In plated through-holes, the composition had no voids and exhibited good hole filling properties. In unplated through-holes, some voids were found, but the overall hole filling properties were good.

### Example 2

The following ingredients were mixed, blended and dispersed in a three-roll mill to give a conductor composition having a viscosity, as measured at 25° C. with a Brookfield viscometer, of 83 Pa.s: 6.25 parts of phenol epoxy novolak (DEN431, produced by The Dow Chemical Co.; viscosity at 25° C., 60 Pa.s), 1.55 parts of monofunctional alkyl glycidyl ether (EPOSIL 759, produced by Air Products and Chemicals, Inc.), 6.95 part of acid anhydride (HN-2200, produced by Hitachi Chemical Co., Ltd.) 0.25 part of an amine curing catalyst (MY-24, produced by Ajinomoto Fine-Techno Co., Inc.), 42.5 parts of spherical silver powder having an average particle size of 7 μm, and 42.5 parts of flake-like silver powder having an average particle size of 2.5 μm.

The conductor composition was printed onto circuits to a film thickness of 40 μm with a printer, then cured at 160° C. for 1 hour, after which the resistivity was measured. The volume resistivity was 4.5×10⁻⁴ Ω·cm. The glass transition point of the cured product obtained by curing under the same conditions was 105° C. The percent weight loss on curing was 0.46%.

The conductor composition was filled into 0.3 mm diameter through-holes in a 1 mm thick FR-4 board by printing. In plated through-holes, the composition had no voids and exhibited good hole filling properties. In unplated through-holes, the composition likewise had no voids and exhibited good hole filling properties.

### Example 3

The following ingredients were mixed, blended and dispersed in a three-roll mill to give a conductor composition having a viscosity, as measured at 25° C. with a Brookfield viscometer, of 100 Pa.s: 6.65 parts of phenol epoxy novolak (DEN431, produced by The Dow Chemical Co.; viscosity at 25° C., 60 Pa.s), 2.85 parts of monofunctional alkyl glycidyl ether (EPOSIL 759, produced by Air Products and Chemicals, Inc.), 0.5 part of boron trifluoride-ethylamin complex, 45 parts of spherical silver powder having an average particle size of 7 μm, and 45 parts of flake-like silver powder having an average particle size of 2.5 μm.

The conductor composition was printed onto circuits to a film thickness of 40 μm with a printer, then cured at 160° C. for 1 hour, after which the resistivity was measured. The volume resistivity was 0.7×10⁻⁴ Ω·cm. The glass transition point of the cured product obtained by curing under the same conditions was 116° C. The percent weight loss on curing was 0.22%.

The conductor composition was filled into 0.3 mm diameter through-holes in a 1 mm thick FR-4 board by printing. In plated through-holes, the composition had no voids and exhibited good hole filling properties. In unplated through-holes, some scattered voids were found, but the overall hole filling properties were good.

### Example 4

The following ingredients were mixed, blended and dispersed in a three-roll mill to give a conductor composition having a viscosity, as measured at 25° C. with a Brookfield viscometer, of 61 Pa.s: 10 parts of phenol epoxy novolak (DEN431, produced by The Dow Chemical Co.; viscosity at 25° C., 60 Pa.s), 4.25 parts of monofunctional alkyl glycidyl ether (EPOSIL 759, produced by Air Products and Chemicals, Inc.), 0.75 part of boron trifluoride-ethylamine complex, 17 parts of spherical silver powder having an average particle size of 7 μm, and 68 parts of flake-like silver powder having an average particle size of 2.5 μm.

The conductor composition was printed onto circuits to a film thickness of 40 μm with a printer, then cured at 160° C. for 1 hour, after which the resistivity was measured. The volume resistivity was 0.9×10⁻⁴ Ω·cm. The glass transition point of the cured product obtained by curing under the same conditions was 109° C. The percent weight loss on curing was 0.33%.

The conductor composition was filled into 0.3 mm diameter through-holes in a 1 mm thick FR4 board by printing. In plated through-holes, the composition had no voids and exhibited good hole filling properties. In unplated through-holes, some scattered voids were found, but the overall hole filling properties were good.

### Example 5

The following ingredients were mixed, blended and dispersed in a three-roll mill to give a conductor composition having a viscosity, as measured at 25° C. with a Brookfield viscometer, of 38 Pa.s: 6.65 parts of phenol epoxy novolak (DEN431, produced by The Dow Chemical Co.; viscosity at 25° C., 60 Pa.s), 2.85 parts of monofunctional alkyl glycidyl ether (EPOSIL 759, produced by Air Products and Chemicals, Inc.), 0.5 part of boron trifluoride-ethylamine complex, 72 parts of spherical silver powder having an average particle size of 7 μm, and 18 parts of flake-like silver powder having an average particle size of 2.5 μm.

The conductor composition was printed onto circuits to a film thickness of 40 μm with a printer, then cured at 160° C. for 1 hour, after which the resistivity was measured. The volumetric resistivity was 1.3×10⁻⁴ Ω·cm. The glass transition point of the cured product obtained by curing under the same conditions was 130° C. The percent weight loss on curing was 0.17%.

The conductor composition was filled into 0.3 mm diameter through-holes in a 1 mm thick FR-4 board by printing. In plated through-holes, the composition had no voids and exhibited good hole filling properties. In unplated through-holes, some scattered voids were found, but the overall hole filling properties were good.

### Comparative Example 1

The following ingredients were mixed, blended and dispersed in a three-roll mill to give a conductor composition having a viscosity, as measured at 25° C. with a Brookfield viscometer, of 128 Pa.s: 3 parts of a bisphenol A-type liquid epoxy resin (Epikote 828, produced by Japan Epoxy Resin; viscosity at 25° C., 12 Pa.s), 9 parts of the diglycidyl ester of dimer acid (YD-171, produced to Toto Kasei; viscosity at 25° C., 0.6 Pa.s), 3 parts of an amine curing agent (MY-24, produced by Ajinomoto Fine-Techno Co., Inc.), 42.5 parts of spherical silver powder having an average particle size of 7 μm, and 42.5 parts of flake-like silver powder having an average particle size of 2.5 μm.

The conductor composition was printed onto circuits to a film thickness of 40 μm with a printer, then cured at 160° C. for 1 hour. An attempt was subsequently made to measure the resistivity, but the resistivity was not measurable. The glass transition point of the cured product obtained by curing under the same conditions was lower than room temperature. The percent weight loss on curing was 0.31%.

Because the resistivity was not measurable and the glass transition point was below room temperature, a filling test in through-holes was not carried out.

### Comparative Example 2

The following ingredients were mixed, blended and dispersed in a three-roll mill to give a conductor composition having a viscosity, as measured at 25° C. with a Brookfield viscometer, of 61 Pa.s: 10 parts of a bisphenol A-type liquid epoxy resin (Epikote 827, produced by Japan Epoxy Resin; viscosity at 25° C., 10 Pa.s), 7.25 parts of a difunctional aliphatic diglycidyl ether (ED-508, produced by Asahi Denka Kogyo K.K.), 0.70 part of dicyandiamide, 1.05 part of an imidazole curing catalyst (2P4 MHZ, produced by Shikoku Chemicals Corporation), 40.5 parts of spherical silver powder having an average particle size of 7 μm, and 40.5 parts of flake-like silver powder having an average particle size of 2.5 μm.

The conductor composition was printed onto circuits to a film thickness of 40 μm with a printer, then cured at 160° C. for 1 hour, after which the resistivity was measured. The volumetric resistivity was 170×10⁻⁴ Ω cm. The glass transition point of the cured product obtained by curing under the same conditions was 87° C. The percent weight loss on curing was 0.29%.

This conductor composition was filled into 0.3 mm diameter through-holes in a 1 mm thick FR-4 board by printing. When filled into plated through-holes, many small voids were noted. Many voids were also observed in unplated through-holes.

### Comparative Example 3

The following ingredients were mixed, blended and dispersed in a three-roll mill to give a conductor composition having a viscosity, as measured at 25° C. with a Brookfield viscometer, of 248 Pa.s: 7.8 parts of a bisphenol F-type epoxy resin (Epikote 807, produced by Japan Epoxy Resin; viscosity at 25° C., 3 Pa.s), 6.95 parts of methyl tetrahydrophthalic anhydride (HN-2200, produced by Hitachi Chemical Co., Ltd.), 0.25 part of an imidazole curing catalyst (2P4 MHZ, produced by Shikoku Chemicals Corporation), 40.5 parts of spherical silver powder having an average particle size of 7 μm, and 40.5 parts of flake-like silver powder having an average particle size of 2.5 μm.

The conductor composition was printed onto circuits to a film thickness of 40 μm with a printer, then cured at 160° C. for 1 hour, after which the resistivity was measured. The volumetric resistivity was 11×10⁻⁴ Ω cm. The glass transition point of the cured product obtained by curing under the same conditions was 130° C. The percent weight loss on curing was 0.38%.

This conductor composition was filled into 0.3 mm diameter through-holes in a 1 mm thick FR-4 board by printing. Large voids were noted in both plated and unplated through-holes.

### Advantages of the Invention

### Example 1 versus Comparative Example 1

Although the silver composition and the solids content was the same in both Example 1 according to the invention and Comparative Example 1, the conductor composition in Example 1 had a low viscosity, a low resistance, and a high glass transition point. In spite of the use of a reactive diluting agent in Example 1, the conductor composition in this example had a smaller percent weight loss on curing than the composition in Comparative Example 1.

### Example 2 versus Comparative Example 3

The silver composition and the solids content were the same in both Example 2 according to the invention and Comparative Example 3. In spite of the use of a low-viscosity liquid epoxy resin in the conductor composition in Comparative Example 3, this composition had a higher viscosity and resistivity than the composition prepared in Example 2.

The presence of a reactive diluting agent in the composition of Example 2 gave this composition a lower glass transition point than the composition in Comparative Example 3. When the resulting compositions were filled into through-holes, the high viscosity of the composition prepared in Comparative Example 3 resulted in the formation of voids. By contrast, the composition obtained in Example 2 of the invention cleanly and completely filled the through-holes.

### Example 4 versus Comparative Example 2

In Comparative Example 2, it was necessary to set the content of silver solids to 81% in order to achieve a viscosity comparable to that in Example 2 according to the invention (the silver solids content in Example 4 was 85%).

As a result, the resistivity of the composition prepared in Comparative Example 2 was much higher than the composition in Example 4. Moreover, because a large amount of reactive diluting agent was used in Comparative Example 2 (42%, based on the epoxy resin and the diluting agent combined, as opposed to 30% in Example 4), the glass transition point was low. In spite of the presence of a large amount of diluting agent and the use of a lower viscosity epoxy resin than in Example 4, the conductor composition obtained in Comparative Example 2 had a high viscosity.

Example 5 according to the invention demonstrates that even at a silver solids content of 90%, a low composition viscosity can be achieved by altering the ratio of spherical silver power to flake-type silver powder. However, because raising the amount of spherical silver powder increases the resistivity, this approach cannot be used in systems already having both a high viscosity and resistivity.

TABLE 1

| | | | | | | | | Comp. |
|---|---|---|---|---|---|---|---|---|
| | Example 1 | Example 2 | Example 3 | Example 4 | Example 5 | Comp. Ex. 1 | Comp. Ex. 2 | Ex. 3 |
| Flake-like silver powder | 42.50 | 42.50 | 45.00 | 68.00 | 18.00 | 42.50 | 40.50 | 42.50 |
| Spherical silver powder | 42.50 | 42.50 | 45.00 | 17.00 | 72.00 | 42.50 | 40.50 | 42.50 |
| Epoxy phenol novolak (viscosity, 60 Pa · s) | 10.0 | 6.25 | 6.65 | 10.0 | 6.65 | | | |
| Bisphenol A-type liquid epoxy resin (viscosity, | | | | | | 3.00 | | |
| 12 Pa · s) | | | | | | | | |
| Bisphenol A-type liquid epoxy resin (viscosity, | | | | | | | 10.0 | |
| 10 Pa · s) | | | | | | | | |
| Bisphenol F-type liquid epoxy resin (viscosity, | | | | | | | | 7.80 |
| 3 Pa · s) | | | | | | | | |
| Monofunctional alkyl glycidyl ether (viscosity, | 4.25 | 1.55 | 2.85 | 4.25 | 2.85 | | | |
| 0.007 Pa · s) | | | | | | | | |
| Diglycidyl ester of dimer acid (viscosity, 0.6 Pa · s) | | | | | | 9.00 | | |
| Difunctional aliphatic diglycidyl ether (viscosity, | | | | | | | 7.25 | |
| 0.06 Pa · s) | | | | | | | | |
| Cationic polymerization initiator | 0.75 | | 0.5 | 0.75 | 0.5 | | | |
| Acid anhydride liquid curing agent | | 6.95 | | | | | | |
| Amine solid powder curing agent | | 0.25 | | | | 3.00 | | |
| Dicyandiamide | | | | | | | 0.70 | |
| Imidazole solid powder curing agent | | | | | | | 1.05 | 0.25 |
| Viscosity (Pa · s at 10 rpm) | 40 | 83 | 100 | 61 | 38 | 128 | 61 | 248 |
| Resistivity (× 10⁻⁴ Ω cm) | 1.5 | 4.5 | 0.7 | 0.9 | 1.3 | not | 170.0 | 11.0 |
| | | | | | | measurable | | |
| Glass transition temperature (° C., by DMA) | 119 | 105 | 116 | 109 | 130 | | 87 | 130 |
| Percent weight loss: | | | | | | | | |
| Room temperature → 250° C. | −0.25 | −0.46 | −0.22 | −0.33 | −0.17 | −0.31 | −029 | −0.38 |
| Room temperature → 300° C. | −0.35 | −0.58 | −0.35 | −0.55 | | −0.63 | −1.14 | −0.44 |
| Through-hole filling properties: | | | | | | | | |
| Plated inside walls | Exc | Exc | Exc | Exc | Exc | N/A | Good | Good |
| Unplated inside walls | Good- | Good | Good- | Good- | Good- | N/A | Good- | Fair- |
| | Fair | | Fair | Fair | Fair | | Fair | Poor |

Hole Filling Properties
Exc: Good hole filling properties with no voids present.
Good: A very small number of voids are scattered in several through-holes, but overall hole-filling properties are good.
Fair: Small voids scattered throughout.
Poor: Large voids visible throughout. Ability to fill holes is poor.
N/A: Not applicable.
Through-hole filling was not carried out.

What is claimed is:

1. A conductor composition comprising an electrically conductive powder and a binder, wherein the ratio of conductive powder to binder is from 95:5 to 70:30, and wherein the binder is comprises:
(a) an epoxy compound that is semisolid at ordinary room temperature and has an average number of functional groups greater than 2,
(b) a monofunctional reactive diluting agent which has substantially no volatility at ordinary room temperature,
(c) a curing agent, and
(d) a curing catalyst.

2. The conductor composition of claim 1 wherein the ratio of the semisolid epoxy compound to the monofunctional reactive diluting agent is from 90:10 to 50:50.

3. The conductor composition of claim 1 wherein the curing agent is a cationic polymerization initiator.

4. The conductor composition of claim 2 wherein the curing agent is a cationic polymerization initiator.

5. The conductor composition of claim 1 wherein the curing agent is a liquid acid anhydride at ordinary room temperature.

6. The conductor composition of claim 2 wherein the curing agent is a liquid acid anhydride at ordinary room temperature.
